(19) United States
(12) Patent Application Publication
(10) Pub. No.: US 2013/0250080 A1
(43) Pub. Date: Sep. 26, 2013

(54) MODULARIZED MOBILE HEALTH AND SECURITY SYSTEM

(71) Applicants: Megan Farrell, San Diego, CA (US); Jennifer Kramer, San Diego, CA (US)

(72) Inventors: Megan Farrell, San Diego, CA (US); Jennifer Kramer, San Diego, CA (US)

(21) Appl. No.: 13/429,250

(22) Filed: Mar. 23, 2012

(51) Int. Cl. G08B 21/00; H04N 7/18; G08B 1/08

(52) U.S. Cl. 348/77; 340/540; 340/539.12; 348/E07.085

(57) ABSTRACT

A system, method, and computer program product are provided for health and security monitoring. A sensory device monitors user voice and keystroke input, and measured safety factors such as user heart rate, ambient light and sound levels, the approach of vehicles, and detection by a camera of an approaching person optionally including information regarding the person's criminal background. If the sensory device and/or user determines a situation is occurring that meets trigger conditions, the sensory device issues a user notification, decreases speaker volume, and issues an alert to a local response group. The local response group comprises trustworthy strangers who may be able to respond more quickly than regular emergency responders to a typical 911 call. The alert may be wirelessly transmitted by a smartphone and has selectable content and urgency level. Users may include children, disabled or elderly persons, soldiers, policemen, security officers, and lone women.

### CROSS-REFERENCE TO RELATED APPLICATIONS

This patent application is related to pending application U.S. Ser. No. 13/401,193 which was filed on Feb. 21, 2012, and is entitled “SMART WATCH WITH AUTOMATIC VOICE RECORDING AND ALARM”, which is hereby incorporated by reference in its entirety.

### FIELD OF THE INVENTION

This patent application relates in general to a portable system for monitoring a user's health and safety, and more specifically to a system with a variety of sensors that provide data that may trigger an alert to a local response group that a user is experiencing health and/or safety difficulties that require attention and assistance.

### BACKGROUND OF THE INVENTION

Health monitors are broadly used in the marketplace. People like to monitor various health and fitness measurements with related devices when exercising, even at home. Active people typically walk or run for exercise, at home or outdoors, and often do so alone. There are however risks of getting lost, suffering medical problems, or undergoing a criminal assault or wildlife attack in such situations. Therefore people who exercise often also carry cell phones with GPS capability for safety while exercising outdoors. Many different single purpose devices may therefore need to be carried, which is expensive and inconvenient.

There is a thus need for a portable unitary device for monitoring user health, fitness, and safety, and for providing geographical position information. This patent application provides a viable approach to solving this challenge and presents a practical implementation of that technique.

### SUMMARY OF THE EMBODIMENTS

A system, method, and computer program product for monitoring a user's health and safety are disclosed and claimed herein. An exemplary computer-implemented method embodiment may comprise identifying with a sensory device predefined safety factors that determine whether trigger conditions are met, and responsively issuing an alert to a local response group. The method may further comprise adjusting a speaker volume according to the safety factors, including a user heart rate, an ambient light level, an approach of a person, and/or an approach of a vehicle. The method may further comprise receiving ambient sounds and/or user verbal commands with the sensory device, causing the sensory device to alter trigger conditions, determine alert content, determine an alert recipient, trigger the alert, and/or cancel the alert.

The method may further comprise converting voice input with the sensory device to a text message and/or an email message, for inclusion in the alert. The method may further comprise determining geographical positioning information, providing memory storage, generating audio and visual warnings for a user, and/or enabling communication via at least one of a telephone call, a text message, an email message, web browsing, social networking media, and streaming audio data and/or video data. The method may further comprise identifying a person imaged by a camera via facial recognition, determining a criminal background of the person, and responsively altering sensory device settings and issuing a user notification.

The sensory device may gather evidence for an undercover police officer acting as a decoy to apprehend a criminal suspect. The sensory device may rented to a user for a fee. The alert may further comprise outputting an external communication to pre-designated responders, a flashing display, and/or an audio alarm.

A system embodiment may comprise a sensory device that measures predefined safety factors, and responsively issues an alert to a local response group when trigger conditions are met. The sensory device may be made in a form factor of a watch, a vest, a bracelet, an armband, a PDA (personal digital assistant), a necklace, earrings, headphones, sunglasses, or eyeglasses. The sensory device may comprise eyeglasses with a heads-up display. The sensory device may further comprise a smartphone linked thereto by a wired communication link and/or a wireless communication link. The sensory device and/or the smartphone may be based on the Android™ operating system.

The sensory device may further comprise a panic button to directly trigger an alert, as well as at least one camera facing in an imaging direction other than the direction in which a user is facing. The sensory device may further comprise a shock sensor, a cardiac sensor, or a speaker. The sensory device may be used by a child, a disabled person, an elderly person, a soldier, a policeman, and/or a security officer. The sensory device may be used in at least one of a park, a campus, an amusement park, a playground, a campsite, a hiking area, and a training area.

A computer program product embodiment may comprise a computer readable medium tangibly embodying non-transitory computer-executable program instructions thereon that, when executed, cause a computing device to measure predefined safety factors, and responsively issue an alert to a local response group when trigger conditions are met.

As described more fully below, the apparatus and processes of the embodiments disclosed enable portable health and safety monitoring systems. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 depicts a sensory device, according to an embodiment;

FIG. 2 depicts a sensory device of headphone form factor, according to an embodiment;

FIG. 3 depicts a sensory device emergency use scenario, according to an embodiment;

FIG. 4 depicts a sensory device non-emergency use scenario, according to an embodiment;

FIG. 5 depicts a flowchart summary of sensory device operation, according to an embodiment.

### DETAILED DESCRIPTION OF EXEMPLARY EMBODIMENTS

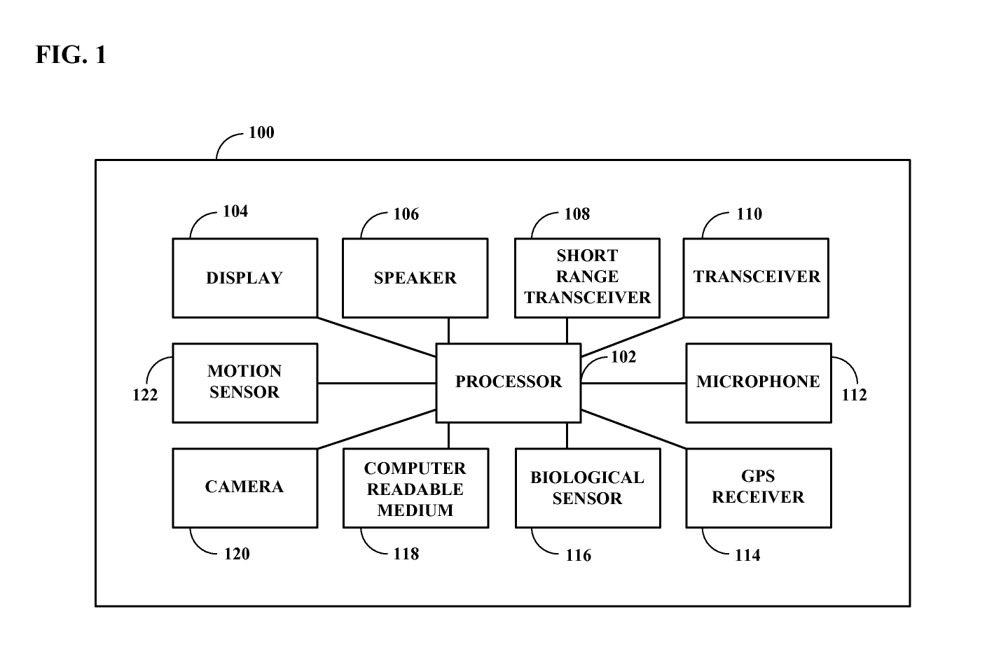

Referring now to FIG. 1, an exemplary sensory device 100 is shown. The sensory device includes processor 102, which performs operational computations and may be operatively connected to display 104, speaker 106, short range transceiver 108, transceiver 110, microphone 112, GPS receiver 114, biological sensor 116, computer readable medium 118, camera 120, and motion sensor 122. Note that not all of these elements may be present in a single housing, instead some may be in separate modules of varying form factors.

Also, some elements are shown as singular when there may be multiple instances of each, such as speaker 106 which may actually comprise a pair of speakers for stereo audio output as well as a separate speaker capable of emitting a loud audio alarm. Camera 120 may actually comprise multiple cameras viewing in different directions, including behind a user and to the sides and above a user, i.e. directions in which a user may not routinely be paying attention. Camera 120 may acquire still images as well as video data. Biological sensor 116 may similarly actually comprise a suite of such sensors for gathering user physiological data of various kinds, including heart rate and body temperature for example.

Sensory device 100 may alternately comprise a smartphone (not shown) that includes some of its elements and performs some of its operations. For example, most smartphones include a processor, a display, a speaker, a transceiver, a microphone, a GPS receiver, and a camera. Short range transceiver 108 may serve to interconnect the smartphone to other elements of sensory device 100, for example via WiFi or Bluetooth protocols. Alternately, a wired connection may be employed. Sensory device 100 and/or the smartphone may employ the Android™ operating system to simplify device interconnectivity (Android™ is a trademark of Google Inc.).

The transceiver may comprise a radio transmitter for cellular communications, using various transmission protocols, as is known in the art. These transmissions may include telephone calls, text messages, emails to networks such as the internet and various social networking media, as well as streaming audio data and video data as is known in the art. The transmissions may be directed to various recipients, including but not limited to friends, family, emergency responders, and a local response group as will be described.

The GPS receiver is capable of determining geographic position information, as is also known in the art. The display may comprise a liquid crystal display capable of flashing a distinctly noticeable message if necessary. The display may use color, symbols, motion, and selected flashing rates to increase message delivery effectiveness.

Computer readable medium 118 may provide data describing operational settings and map data for sensory device 100 as well executable program instructions. It may also provide memory storage space for data acquired by sensory device 100. Microphone 112 may comprise a conventional smartphone microphone, or a separate microphone to acquire user voice commands or ambient sounds more clearly if the smartphone is not carried openly by the user. The processor may execute voice recognition software to transform input speech into text format, which generally requires far less bandwidth for transmission or storage.

The processor may execute instructions selectively according to voice commands recognized by a user, e.g. trigger an alert upon hearing an “emergency phrase”, or cancel an alert upon hearing an “all clear” phrase. Sensory device 100 may also transmit the voice commands in text format via a text message. Microphone 112 may also sense sudden loud bursts of sound, which may be indicative of nearby gunfire or suddenly approaching vehicles for example.

Motion sensor 112 may comprise a gyroscope, accelerometer, or other sensor designed to detect, for example, a direction a user is facing or moving. It may also detect sudden physical shocks that may be indicative of an accident or criminal attack. Sensory device 100 may also include buttons (not shown) or touch-sensitive displays capable of receiving keystroke input from a user; such an input may function as a “panic button” for example, in which a user clearly indicates an alert situation is occurring.

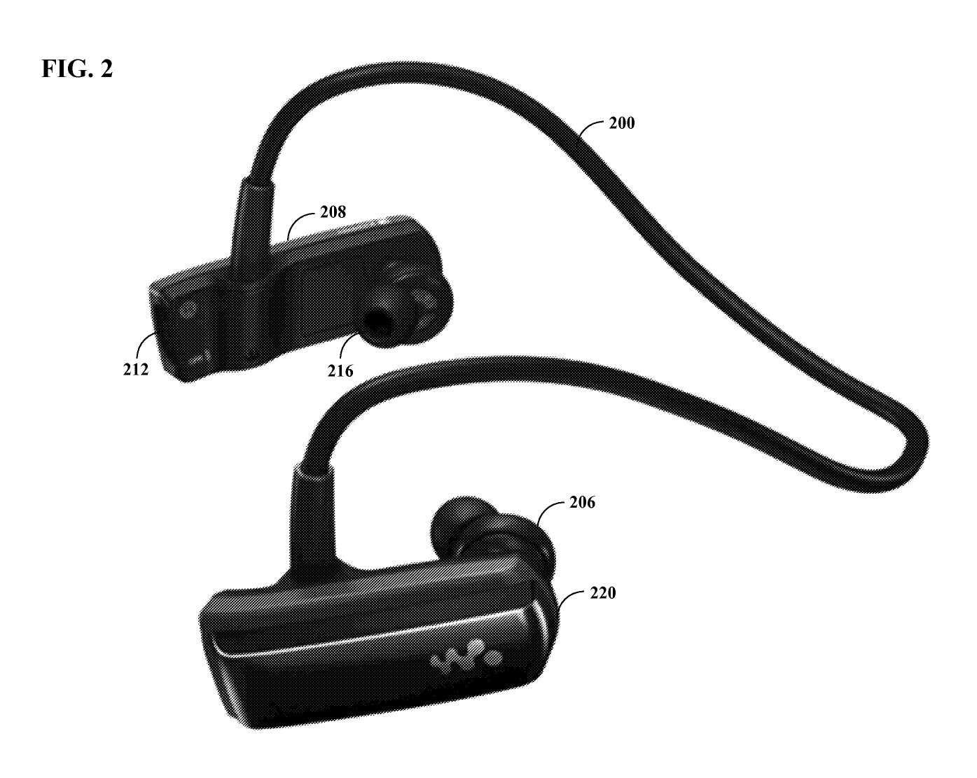

Referring now to FIG. 2, a sensory device 200 of headphone form factor is shown according to a particular embodiment. This headphone embodiment outwardly resembles existing conventional Walkman® headphones manufactured by Sony Corporation (Walkman® is a registered trademark of Sony Corporation). Speakers 206, short range transceiver 208, microphone 212, biological sensor 216, and camera 220 may operate analogously as described in the FIG. 1 embodiment. Biological sensor 216 for example may monitor a user's body temperature and/or heart rate when inserted into the ear with speaker 206 during ordinary use.

Other form factors not shown are also within the scope of the invention, and may include without limitation a ring, earrings, a vest, an armband, a belt, a watch, a bracelet, a PDA, a necklace, eyeglasses, and sunglasses. The eyeglass or sunglass form factors for example may further include a heads-up display, enabling images produced by camera(s) 220 to be viewed by a user during use. This feature may help prevent injury due to unexpected events arriving from directions other than that in which a user is facing, e.g. a wild animal or a human assailant approaching from behind. Camera 220 may be sensitive to visible and infrared light, and may provide processor 102 with a measure of ambient light levels to be considered when evaluating safety factors. Poorly lit areas are generally regarded as more dangerous than brightly lit ones, for example.

Camera 220 may also capture images of nearby or approaching persons to enable the sensory device to perform a facial recognition operation. If such a person is identified as someone with a criminal record, who may even be currently wanted by law enforcement, that identification may be quite valuable to a user. An ordinary citizen may choose to actively avoid such a person when notified of their proximity and status, and the sensory device may heighten its effective sensitivity by adjusting its trigger parameters accordingly. In contrast, if the user is a policeman, such an identified criminal or suspect may be interrogated and/or arrested, particularly if found near a crime scene. Conversely, if an imaged person is determined not to be a criminal, a policeman may be more inclined to believe them when questioned.

The embodiments may thus provide a “community facebook” so police may identify local alert responders who are likely to be the first persons on the alert scene, and help distinguish them from assailants. The number and location of alerts may be tracked over time to help police determine which areas are hotspots of criminal activity. Undercover police “decoys” may even use the sensory device to help catch and provide evidence against criminals, much as so-called “bait cars” are instrumented with remote controls and video cameras and used to catch car thieves.

Speakers 206 may provide sound to a user at volume levels that may be reduced in response to safety factors that sensory device 200 measures. Joggers are often vulnerable to injurious events that they do not foresee and avoid because they are listening to generated audio instead of ambient sounds. The embodiment thus may reduce volume levels when for example important ambient sounds (e.g. gunshots) are detected, when a user's heart rate suddenly increases (e.g. after a surprising event or when evading a criminal attack), when darkness falls, or when a user enters geographic areas known to be dangerous or off a planned excursion route, etc.

The sensory device thus enhances the safety of a user, who may for example comprise a child, an elderly person, a disabled person, a lone woman, a solider, a policeman, a security officer, or anyone in general who requires an increased situational awareness. Embodiments of the invention measure safety factors based on input data, and responsively issue an alert to a local response group when trigger conditions are met. Safety factors may include any detectable aspect of a user's situation that may indicate an increased risk to the user's health and safety.

Integrated circuitry or a software application executed by the processor may evaluate all safety factors based on incoming data, and compare them to predefined trigger conditions for a given user to determine if sufficient safety violation has been detected to warrant triggering an alert. The sensory device and/or user may also adjust the predefined trigger conditions as circumstances change.

The alert may have variable content, be sent to various recipients, and be characterized by different formats and transmission protocols, each depending on the user's situation and the trigger conditions and measured safety factors. For example, the alert may indicate various levels of urgency, from an emergency involving life-threatening injuries to somewhat elevated concern about a child's whereabouts to a simple non-emergency message or inquiry. The alert may be sent via text message, an email, a telephone call, a posting to a social network, and by other protocols and formats as may be known. The alert includes the user's geographic position data, to help responders locate the user. The user may customize the alert content to have various pre-defined messages for various situations of concern or situations that occur regularly. The customization may be made by user voice command.

The recipients may include pre-designated recipients, such as friends, family, and emergency responders as with a conventional 911 call. However, embodiments of the invention may also send an alert to a local response group that does not comprise pre-designated recipients but instead comprises a set of persons within the user's vicinity who have been deemed sufficiently trustworthy to reliably respond. The local response group could include volunteers who have been vetted (i.e. determined not to have criminal records, numerous arrests, etc.), such as off-duty policemen, doctors, emergency medical technicians, members of the military, security guards, merchants, or just ordinary citizens.

These “trustworthy strangers” as it were, have a previously determined and remotely accessible trust rating that may be based on various relevant factors (e.g. occupation, height, weight, gender, martial arts training, medical or law enforcement experience, and issuance of a concealed firearms carry permit). The embodiments may even look up and recruit potential local responders on the internet using various heuristics. For example, all gymnasium members attending a nearby gymnasium might be alerted to an ongoing assault even if they have not previously signed up to be members of a local response group. A sufficient number of even untrained weight-lifter responders may be sufficient to end the assault and/or restrain the assailant until police arrive.

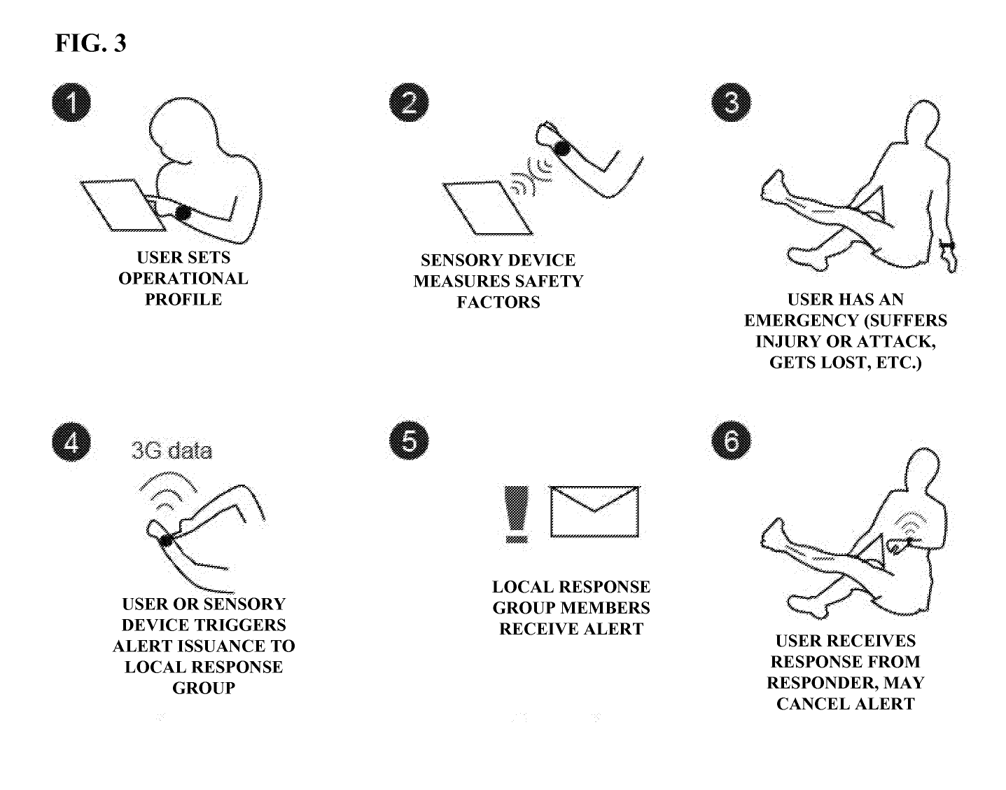

Referring now to FIG. 3, a sensory device emergency use scenario is shown. In panel 1, a user inputs relevant information that governs the operation of sensory device 100. In panel 2, the sensory device gathers data from its various input devices, and evaluates safety factors as programmed. In panel 3, the user undergoes an emergency event of some kind, e.g. suffers a medical problem, wildlife or criminal attack, or gets lost to severe extent.

In panel 4, the user and/or the sensory device determine that trigger conditions have been met, and issuance of an alert is warranted. The alert is assembled and issued to recipients, by default to the local response group. In panel 5, the local response group members receive the alert, and may respond and come to the user's aid. In panel 6, the user receives the recipient acknowledgement or other more detailed response, and may optionally cancel the alert. However, the embodiments are not limited to monitoring a user's health and safety in an emergency situation, but also provide utility in less severe circumstances.

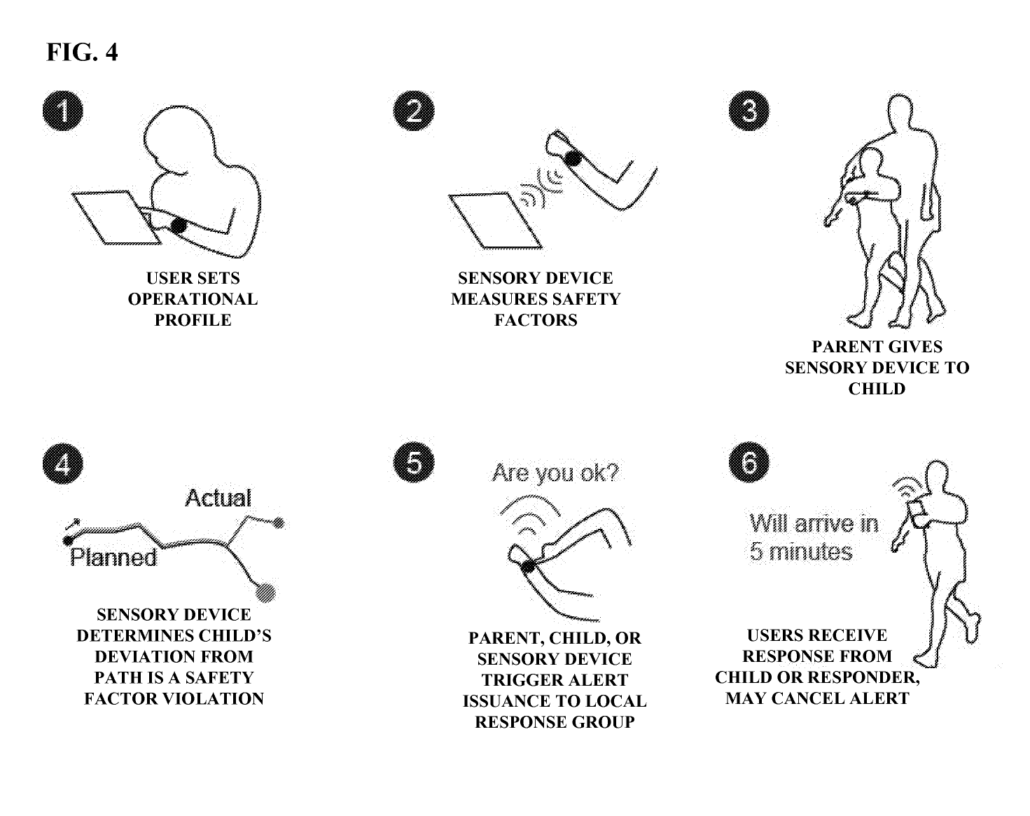

Referring now to FIG. 4, a sensory device non-emergency use scenario is shown. In this case, a parent programs sensory device 100 in panel 1 with instructions for monitoring a child's excursion. This scenario is often applicable when the sensory device is used at a park, a campus, an amusement park, a playground, a campsite, a hiking area, or a training area for example, i.e. locations that are not normally overtly dangerous but might be expansive and not easily observed from a single vantage point. Sensory device 100 may be rented for temporary use for a fee at such locations. The parent gives the sensory device to the child in panel 3, and the sensory device then monitors the child remotely.

In panel 4, the sensory device has determined that the child has deviated from a planned excursion path sufficiently to cross a preprogrammed safety limit. In panel 5, the parent, child, or sensory device may trigger an alert. In this case, the alert may be sent to a local response group after an alert is sent to a set of pre-designated responders (e.g. the child, another parent, sibling, teacher, coach, etc. involved with the excursion). The alert may have a low urgency level, serving merely as a notice that the child is in a given area and should be guided back onto the excursion path for example. In panel 6, the parent, child, or other pre-designated responders may all receive a response from the child or a responder, and the parent may responsively cancel the alert.

Sending out an alert to a local response group may lead to a faster response than a 911 call, because the responders are already nearby; their locations may be determined and communicated to a coordinating server for example by their sensory devices or smartphones. Plus, a less urgent situation may not rise to the level of emergency needed to justify a 911 call. Such an alert in national or state parks for example would probably lead to a faster and more tailored response by rangers who know the area, in comparison to local police.

In an even less urgent example, a lone woman may send an alert to request other women in the area to gather as a deterrent to criminal activity while out running or attending events. For example, a group going to a movie is less likely to be attacked than a single person going to a movie. The response to an alert may thus vary with the alert's urgency, but responders may typically arrest an assailant, serve as an eyewitness (including recording data from their own sensory devices), perform minor vehicle repairs, or simply accompany a user in a threatening situation (e.g. walking a lone woman to her car at night in a “bad” neighborhood). The embodiments may thus effectively create an exchange for small favors, particularly those that are safety-related and that use the trust rating.

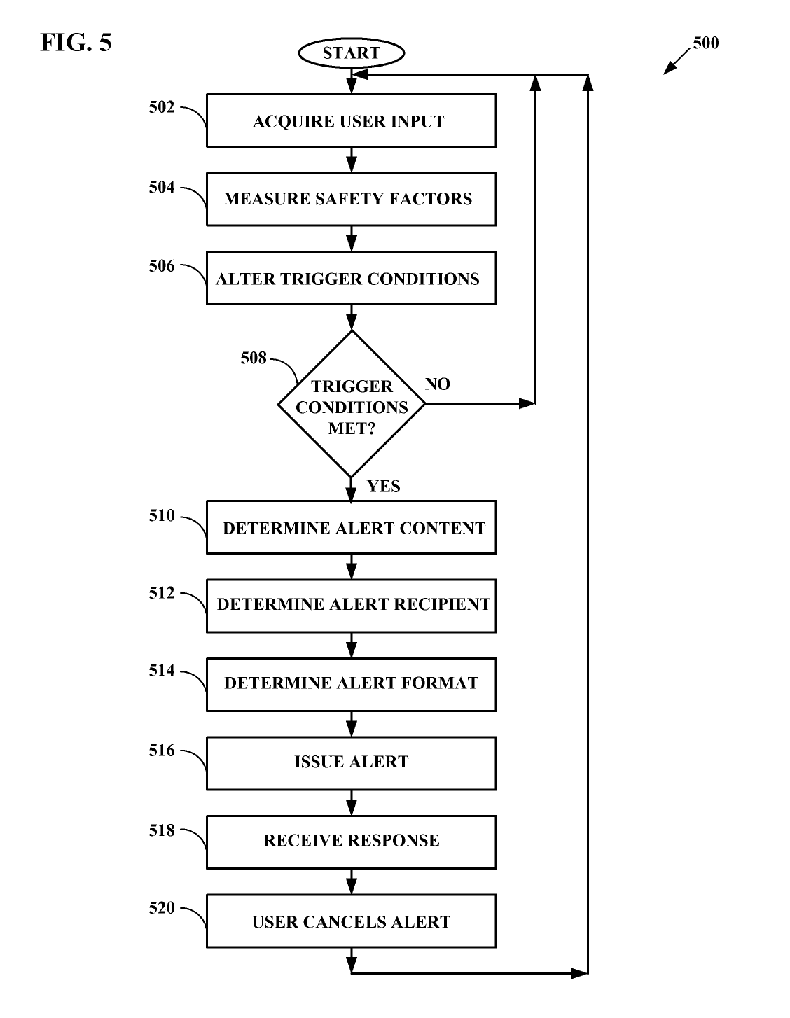

Referring now to FIG. 5, a flowchart summary of sensory device operation is shown. Sensory device 100 checks to see if there is any user input at step 502, including keystrokes or voice input. Next, in step 504 the sensory device measures safety factors by scanning all available input devices, including microphones, cameras, the motion sensor, the GPS receiver, and the biological sensors. Each of these may provide input data that can influence a safety factor as previously described. Then, in step 506 sensory device 100 alters trigger conditions if necessary, e.g. if a user changes settings upon becoming nervous or suspicious of their current situation, or a criminal is seen approaching. Sensory device 100 then determines if the trigger conditions have been met, i.e. if a safety or security violation that warrants an alert has occurred. If not, then operation resumes at the beginning of the cycle (unless the user turns off the sensory device for example), otherwise an alert is prepared.

In step 510, the alert content is determined. This may include an urgency level, which may be determined by a user voice command or keypad entry, or a combination of safety factors suddenly changing due to inputs from multiple sensors changing suddenly. Then, in step 512 the alert recipient(s) are determined from user input or a list of pre-designated recipients if any, or the recipient defaults to the local response group. In step 514, the alert format is determined, e.g. text message, email, pre-recorded telephone call, social media posting, etc. based on prior user settings for example. The alert may also include sounding a loud audio alarm and/or triggering an attention-getting display sequence. The alert is issued in step 516.

Sensory device 100 may optionally receive a response to the alert in step 518, for example noting that the alert has been received by some recipients and they are moving to the scene or taking other actions. A user may also optionally cancel the alert in step 520 if it was sent in error or the troubling situation has been resolved. Cancellation of the alert preferably requires user authentication, to prevent an attacker from attempting to cancel the alert himself, including by damaging or destroying sensory device 100.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

While the invention has been described in connection with specific examples and various embodiments, it should be readily understood by those skilled in the art that many modifications and adaptations of the embodiments described herein are possible without departure from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains.

What is claimed is:

1. A sensory device that:
measures predefined safety factors; and
responsively issues an alert to a local response group when trigger conditions are met.

2. The sensory device of claim 1 further having a form factor of one of a watch, a vest, a bracelet, an armband, a PDA, a necklace, earrings, headphones, sunglasses, and eyeglasses.

3. The sensory device of claim 1 further comprising eyeglasses with a heads-up display.

4. The sensory device of claim 1 further comprising a smartphone linked thereto by at least one of a wired communication link and a wireless communication link, and wherein up to both the sensory device and the smartphone are Android™-based.

5. The sensory device of claim 1 further comprising a panic button to directly trigger an alert.

6. The sensory device of claim 1 further comprising at least one camera facing in an imaging direction other than a user facing direction.

7. The sensory device of claim 1 further comprising at least one of a shock sensor, a cardiac sensor, and a speaker.

8. The sensory device of claim 1 wherein the sensory device is used by at least one of a child, a disabled person, an elderly person, a lone woman, a soldier, a policeman, and a security officer.

9. The sensory device of claim 1 wherein the sensory device is used in at least one of a park, a campus, an amusement park, a playground, a campsite, a hiking area, and a training area.

10. A computer-implemented security method, comprising:
identifying with a sensory device predefined safety factors that determine whether trigger conditions are met; and
responsively issuing an alert to a local response group.

11. The method of claim 10 further comprising adjusting a speaker volume according to the safety factors including at least one of a user heart rate, an ambient light level, an approach of a person, and an approach of a vehicle.

12. The method of claim 10 further comprising receiving with the sensory device at least one of ambient sounds and user verbal commands, causing the sensory device to at least one of: alter trigger conditions, determine alert content, determine an alert recipient, trigger the alert, and cancel the alert.

13. The method of claim 10 further comprising converting voice input with the sensory device to at least one of a text message and an email message, for inclusion in the alert.

14. The method of claim 10 further comprising at least one of determining geographical positioning information, providing memory storage, generating audio and visual warnings for a user, and enabling communication via at least one of a telephone call, a text message, an email message, web browsing, social networking media, and streaming at least one of audio data and video data.

15. The method of claim 10 further comprising:
identifying via facial recognition a person imaged by a camera;
determining a criminal background of the person; and
responsively altering sensory device settings and issuing a user notification.

16. The method of claim 10 wherein the sensory device gathers evidence for an undercover police officer acting as a decoy to apprehend a criminal suspect.

17. The method of claim 10 wherein the sensory device is rented to a user for a fee.

18. The method of claim 10 wherein the alert further comprises outputting at least one of an external communication to pre-designated responders, a flashing display, and an audio alarm.

19. A security system, comprising:
means for identifying with a sensory device predefined safety factors that determine whether trigger conditions are met; and
means for responsively issuing an alert to a local response group.

20. A computer program product, comprising a non-transitory computer readable medium tangibly embodying non-transitory computer-executable program instructions thereon for managing security that, when executed, cause a computing device to:
measure predefined safety factors; and
responsively issue an alert to a local response group when trigger conditions are met.
